(19) United States
(12) Patent Application Publication
(10) Pub. No.: US 2024/0154158 A1
(43) Pub. Date: May 9, 2024

(54) LITHIUM-ION-CONDUCTIVE MATERIAL

(71) Applicant: OHARA INC., Sagamihara-shi, Kanagawa (JP)

(72) Inventor: Kazuhito Ogasa, Sagamihara-shi (JP)

(73) Assignee: OHARA INC., Sagamihara-shi, Kanagawa (JP)

(21) Appl. No.: 18/284,337

(22) PCT Filed: Feb. 24, 2022
(86) PCT No.: PCT/JP2022/007596

§ 371 Date: Sep. 27, 2023

(30) Foreign Application Priority Data
Mar. 31, 2021 (JP) 2021-060218

(51) Int. Cl. H01M 10/0562; H01M 10/0525

(52) U.S. Cl. CPC H01M 10/0562; H01M 10/0525; H01M 2300/0074

(57) ABSTRACT

The lithium ion conductive material includes, in mole percent on an oxide basis, 36.6 to 37.3% of a P₂O₅ component, 43.0 to 48.1% of a TiO₂ component, 0.6 to 3.2% of an Al₂O₃ component and 13.9 to 17.5% of a Li₂O component, wherein a mole percent of the Al₂O₃ component is 0.3 to 3.0% by mole smaller than a mole percent of an Al₂O₃ component calculated by the composition formula Li₁₊ₓAlₓTi₂₋ₓP₃O₁₂ (x=0.05 to 0.4) derived from the composition of Ti and Li, and a mole percent of the P₂O₅ component is 0.2 to 2.0% by mole smaller than a mole percent of a P₂O₅ component calculated by the above composition formula, and wherein the lithium ion conductive material further includes a crystal phase with a rhombohedral NASICON structure or a Li₁₊ₓAlₓTi₂₋ₓP₃O₁₂ (x≥0) crystal phase.

### TECHNICAL FIELD

The present invention relates to a lithium ion conductive material.

### BACKGROUND ART

Chargeable and dischargeable lithium-ion secondary batteries with high energy density are widely used in applications such as power supplies for electric vehicles and power supplies for cell phone terminals.

Most lithium-ion secondary batteries currently on the market use liquid electrolyte (electrolytic solution) to ensure that they have a high energy density. A material prepared by dissolving lithium salt in a non-protic organic solvent such as carbonate ester or cyclic ester is usually used as the electrolytic solution.

However, in lithium-ion secondary batteries using liquid electrolyte (electrolytic solution), there is a risk of electrolyte leakage. In addition, organic solvents and other materials commonly used in electrolytic solution are volatile and flammable substances, and the problem is that the substances are undesirable from a safety standpoint.

Thus, it has been proposed to use a solid electrolyte as the electrolyte of a lithium ion secondary battery instead of liquid electrolyte (electrolytic solution) such as an organic solvent. In addition, development of all-solid-state secondary batteries, in which solid electrolyte is used as the electrolyte and all other components such as the electrode layer are also composed of solid, is underway.

Typical properties required for solid electrolyte for all-solid-state secondary batteries include lithium ion conductivity and sintering properties.

As a solid electrolyte for all-solid-state secondary batteries, for example, a glass-ceramic electrolyte with a composition of Li₁₊ₓAlₓTi₂₋ₓP₃O₁₂ plus AlPO₄ disclosed in Non-Patent Document 1, a ceramic electrolyte with a composition of LiTi₂P₃O₁₂ disclosed in Non-Patent Documents 2 and 3 and the like have been considered.

### CITATION LIST

### Non-Patent Documents

Non-patent Document 1: Journal of Solid State Chemistry 265(2018)381-386
Non-patent Document 2: Journal of Materials Science 33(1998)1549-1553
Non-patent Document 3: Solid State Ionics 47(1991)257-264

### SUMMARY OF THE INVENTION

### Problem to be Solved by the Invention

The glass ceramic electrolyte disclosed in Non-Patent Document 1 is reported to have a lithium ion conductivity of 1×10⁻³ S/cm at 25° C. However, the sintering temperature during synthesis is very high, and is 1,000° C. or higher. Furthermore, when the material is re-sintered after synthesis, a sintering temperature of 900° C. or higher is also required, in which case grain boundary resistance in solid electrolyte (resistance to ion conduction occurring at the contact interface between particles) increases, and the problem is that lithium ion conductivity at 25° C. is reduced to about 1×10⁻⁴ S/cm. In integral molding with the electrode layer, decomposition of the electrode active material (cathode active material or anode active material) and a decrease in discharge capacity (battery capacity), due to high temperature sintering, are also the problem.

Meanwhile, ceramic electrolytes disclosed in Non-Patent Document 2 and Non-Patent Document 3 have low intragranular resistance (resistance to ion conduction occurring within particles) but high grain boundary resistance, and thus achieving high lithium ion conductivity is difficult. Therefore, lithium salt such as Li₃PO₄ and Li₃BO₃ is mixed with Li₃BO₃ glass or the like, and sintered to reduce the grain boundary resistance and increase lithium ion conductivity. However, the sintering temperature is as high as 900° C., and the resulting solid electrolyte has a lithium ion conductivity at 25° C. of about 1.5 to 3×10⁻⁴ S/cm.

Accordingly, an object of the present invention is to provide a lithium ion conductive material from which a solid electrolyte having high lithium ion conductivity can be formed at a sintering temperature of 800° C. or less.

### Means for Solving the Problem

The present inventors have conducted intensive studies to solve the above problem, and have found that a solid electrolyte (oxide solid electrolyte) with high lithium ion conductivity can be formed by mixing and sintering, at 800° C. or less, a lithium ion conductive glass material containing lithium with a lithium ion conductive material including, in mole percent on an oxide basis, 36.6 to 37.3% of a P₂O₅ component, 43.0 to 48.1% of a TiO₂ component, 0.6 to 3.2% of an Al₂O₃ component and 13.9 to 17.5% of a Li₂O component, wherein a mole percent of the Al₂O₃ component is 0.3 to 3.0% by mole smaller than a mole percent of an Al₂O₃ component calculated by the composition formula Li₁₊ₓAlₓT₂₋ₓP₃O₁₂ (x=0.05 to 0.4) derived from the composition of Ti and Li, and a mole percent of the P₂O₅ component is 0.2 to 2.0% by mole smaller than a mole percent of a P₂O₅ component calculated by the composition formula Li₁₊ₓAlₓTi₂₋ₓP₃O₁₂ (x=0.05 to 0.4) derived from the composition of Ti and Li, and wherein the lithium ion conductive material further includes a crystal phase with a rhombohedral NASICON structure or a Li₁₊ₓAlₓTi₂₋ₓP₃O₁₂ (x≥0) crystal phase.

The present inventors have also found that a solid electrolyte (oxide solid electrolyte) with high lithium ion conductivity can be formed by mixing and sintering, at 800° C. or less, a lithium ion conductive glass material containing lithium with a lithium ion conductive material including, in mole percent on an oxide basis, 34.0 to 36.5% of a P₂O₅ component, 42.0 to 46.5% of a TiO₂ component, 0.6 to 3.1% of an Al₂O₃ component, 15.0 to 17.6% of a Li₂O component and 0.5 to 5.0% of a SiO₂ component, wherein a mole percent of the Al₂O₃ component is 0.3 to 3.0% by mole smaller than a mole percent of an Al₂O₃ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and a mole percent of the P₂O₅ component is 0.2 to 2.0% by mole smaller than a mole percent of a P₂O₅ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and wherein the lithium ion conductive material further includes a crystal phase with a rhombohedral NASICON structure, a Li₁₊ₓAlₓTi₂₋ₓP₃O₁₂ (x≥0) crystal phase, or a Li_{1+x+y}AlₓTi₂₋ₓSi_{y}P_{3-y}O₁₂ (x≥0, y≥0) crystal phase, and the present invention has been completed.

That is, the present invention includes the following (1) to (5).

(1) A lithium ion conductive material including, in mole percent on an oxide basis, 36.6 to 37.3% of a P₂O₅ component, 43.0 to 48.1% of a TiO₂ component, 0.6 to 3.2% of an Al₂O₃ component and 13.9 to 17.5% of a Li₂O component, wherein a mole percent of the Al₂O₃ component is 0.3 to 3.0% by mole smaller than a mole percent of an Al₂O₃ component calculated by the composition formula Li₁₊ₓAlₓTi₂₋ₓP₃O₁₂ (x=0.05 to 0.4) derived from the composition of Ti and Li, and a mole percent of the P₂O₅ component is 0.2 to 2.0% by mole smaller than a mole percent of a P₂O₅ component calculated by the composition formula Li₁₊ₓAlₓTi₂₋ₓP₃O₁₂ (x=0.05 to 0.4) derived from the composition of Ti and Li, and wherein the lithium ion conductive material further includes a crystal phase with a rhombohedral NASICON structure or a Li₁₊ₓAlₓTi₂₋ₓP₃O₁₂ (x≥0) crystal phase.

(2) A lithium ion conductive material including, in mole percent on an oxide basis, 34.0 to 36.5% of a P₂O₅ component, 42.0 to 46.5% of a TiO₂ component, 0.6 to 3.1% of an Al₂O₃ component, 15.0 to 17.6% of a Li₂O component and 0.5 to 5.0% of a SiO₂ component, wherein a mole percent of the Al₂O₃ component is 0.3 to 3.0% by mole smaller than a mole percent of an Al₂O₃ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and a mole percent of the P₂O₅ component is 0.2 to 2.0% by mole smaller than a mole percent of a P₂O₅ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and wherein the lithium ion conductive material further includes a crystal phase with a rhombohedral NASICON structure, a Li₁₊ₓAlₓTi₂₋ₓP₃P₁₂ (x≥0) crystal phase, or a Li_{1+x+y}AlₓTi₂₋ₓSi_{y}P_{3-y}O₁₂ (x≥0, y≥0) crystal phase.

(3) The lithium ion conductive material according to (1) or (2), which is lithium ion conductive glass ceramics.

(4) A solid electrolyte material formed by mixing the lithium ion conductive material according to any one of (1) to (3) and a lithium ion conductive glass material containing lithium.

(5) An all-solid-state secondary battery formed of a material including the solid electrolyte material according to (4).

### Advantageous Effect of Invention

The present invention provides a lithium ion conductive material from which a solid electrolyte having high lithium ion conductivity can be formed by mixing and sintering with a lithium ion conductive glass material containing lithium at 800° C. or less.

### BRIEF DESCRIPTION OF DRAWINGS

FIG. 1 is a flow chart illustrating the synthesis of the lithium ion conductive glass ceramics of Examples 1 to 4 and Comparative Examples 1 to 3 (Step 1) and the solid electrolyte of Examples 1 to 4 and Comparative Examples 1 to 3 (Step 2);

FIG. 2 is a graph showing the relationship between the sintering temperature (heat treatment temperature) and the lithium ion conductivity (conductivity) of the solid electrolyte (sintered pellets) of Comparative Example 1, Comparative Example 2 and Example 4 prepared in Step 2;

FIG. 3 is a graph showing the relationship between the sintering temperature (heat treatment temperature) and the density of the solid electrolyte (sintered pellets) of Comparative Example 1, Comparative Example 2 and Example 4 prepared in Step 2;

FIG. 4 is a secondary electron image (an image substituting drawing) of a broken-out section of the solid electrolyte (sintered pellets) of Example 4 prepared in Step 2;

FIG. 5 is a backscattered electron image (an image substituting drawing) of a broken-out section of the solid electrolyte (sintered pellets) of Example 4 prepared in Step 2;

FIG. 6 is a flow chart illustrating the synthesis of the lithium ion conductive glass ceramics of Examples 5 and 6 and Comparative Example 4 (Step 1-2) and the solid electrolyte of Examples 5 and 6 and Comparative Example 4 (Step 2-2);

FIG. 7 is a graph showing the relationship between the sintering temperature (heat treatment temperature) and the lithium ion conductivity (conductivity) of the solid electrolyte (sintered pellets) of Example 5 prepared in Step 2-2 and the solid electrolyte (sintered pellets) of Comparative Example 1 and Example 4 prepared in Step 2;

FIG. 8 is a graph showing the relationship between the sintering temperature (heat treatment temperature) and the density of the solid electrolyte (sintered pellets) of Example 5 prepared in Step 2-2 and the solid electrolyte (sintered pellets) of Comparative Example 1 and Example 4 prepared in Step 2; and

FIG. 9 is a secondary electron image (an image substituting drawing) of a broken-out section of the solid electrolyte (sintered pellets) of Example 5 prepared in Step 2-2.

### DESCRIPTION OF EMBODIMENTS

The present invention will be described.

The first embodiment of the present invention is a lithium ion conductive material including, in mole percent on an oxide basis, 36.6 to 37.3% of a P₂O₅ component, 43.0 to 48.1% of a TiO₂ component, 0.6 to 3.2% of an Al₂O₃ component and 13.9 to 17.5% of a Li₂O component, wherein a mole percent of the Al₂O₃ component is 0.3 to 3.0% by mole smaller than a mole percent of an Al₂O₃ component calculated by the composition formula Li₁₊ₓAlₓTi₂₋ₓP₃O₁₂ (x=0.05 to 0.4) derived from the composition of Ti and Li, and a mole percent of the P₂O₅ component is 0.2 to 2.0% by mole smaller than a mole percent of a P₂O₅ component calculated by the composition formula Li₁₊ₓAlₓTi₂₋ₓP₃O₁₂ (x=0.05 to 0.4) derived from the composition of Ti and Li, and wherein the lithium ion conductive material further includes a crystal phase with a rhombohedral NASICON structure or a Li₁₊ₓAlₓTi₂₋ₓP₃O₁₂ (x≥0) crystal phase.

Furthermore, the second embodiment of the present invention is a lithium ion conductive material including, in mole percent on an oxide basis, 34.0 to 36.5% of a P₂O₅ component, 42.0 to 46.5% of a TiO₂ component, 0.6 to 3.1% of an Al₂O₃ component, 15.0 to 17.6% of a Li₂O component and 0.5 to 5.0% of a SiO₂ component, wherein a mole percent of the Al₂O₃ component is 0.3 to 3.0% by mole smaller than a mole percent of an Al₂O₃ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and a mole percent of the P₂O₅ component is 0.2 to 2.0% by mole smaller than a mole percent of a P₂O₅ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and wherein the lithium ion conductive material further includes a crystal phase with a rhombohedral NASICON structure, a Li₁₊ₓAlₓTi₂₋ₓP₃O₁₂ (x≥0) crystal phase, or a Li₁₊ₓAlₓTi₂₋ₓSi_{y}P_{3-y}O₁₂ (x≥0, y≥0) crystal phase.

In the following, the above materials may also be referred to as “the lithium ion conductive material of the present invention.”

The content of the respective components in the lithium ion conductive material of the present invention is in mole percent on an oxide basis in all embodiments including the first embodiment and the second embodiment unless otherwise specified. The content “in mole percent on an oxide basis” means the content of the respective components in the lithium ion conductive material of the present invention, assuming that all the oxides, complex salts, metal fluorides and the like used as a raw material of the lithium ion conductive material of the present invention are decomposed and converted into oxide when melted, taking the total number of moles of the resulting oxide as 100% by mole. The same applies to the mole percent of the Al₂O₃ component and the P₂O₅ component calculated by the pre-determined composition formula; the mole percent means the content of the respective components, assuming that all the components of the pre-determined composition formula are decomposed and converted into oxide when melted, taking the total number of moles of the resulting oxide as 100% by mole.

### First Embodiment

First, the components and the crystal phase constituting the first embodiment of the lithium ion conductive material of the present invention will be described.

<Constituent Components>

The components constituting the first embodiment of the lithium ion conductive material of the present invention will be described in detail.

The P₂O₅ component is essential for forming a crystal phase with a rhombohedral NASICON structure or a Li₁₊ₓAlₓTi₂₋ₓP₃O₁₂ (x≥0) crystal phase in the first embodiment of the lithium ion conductive material of the present invention. Thus, the lower limit of the content of the P₂O₅ component is 36.6%, preferably 36.8% and more preferably 37.0%. Meanwhile, since the formation of other crystal phases can be prevented and the lithium ion conductivity of the solid electrolyte prepared by mixing and sintering with a lithium ion conductive glass material containing lithium at low temperature can be less likely to be reduced, the upper limit of the content of the P₂O₅ component is 37.3%, and preferably 37.2%.

The TiO₂ component is also essential for forming a crystal phase with a rhombohedral NASICON structure or a Li₁₊ₓAlₓTi₂₋ₓP₃O₁₂ (x≥0) crystal phase in the first embodiment of the lithium ion conductive material of the present invention. Thus, the lower limit of the content of the TiO₂ component is 43.0%, preferably 43.2% and more preferably 43.5%. Meanwhile, since the lithium ion conductivity of the solid electrolyte prepared by mixing and sintering with a lithium ion conductive glass material containing lithium at low temperature can be less likely to be reduced, the upper limit of the content of the TiO₂ component is 48.1%, preferably 47.0%, more preferably 46.0% and further preferably 45.0%.

The Al₂O₃ component is also essential for forming a crystal phase with a rhombohedral NASICON structure or a Li₁₊ₓAlₓTi₂₋ₓP₃O₁₂ (x≥0) crystal phase in the first embodiment of the lithium ion conductive material of the present invention. Thus, the lower limit of the content of the Al₂O₃ component is 0.6%, preferably 0.8%, more preferably 1.0%, further preferably 1.2%, still more preferably 1.5% and yet more preferably 2.0%. Meanwhile, since the formation of other crystal phases can be prevented and the lithium ion conductivity of the solid electrolyte prepared by mixing and sintering with a lithium ion conductive glass material containing lithium at low temperature can be less likely to be reduced, the upper limit of the content of the Al₂O₃ component is 3.2%, preferably 3.0%, more preferably 2.8% and further preferably 2.6%.

The Li₂O component is essential for conferring lithium ion conductivity to the first embodiment of the lithium ion conductive material of the present invention, and for forming a crystal phase with a rhombohedral NASICON structure or a Li₁₊ₓAlₓTi₂₋ₓP₃O₁₂ (x≥0) crystal phase. Thus, the lower limit of the content of the Li₂O component is 13.9%, preferably 15.0% and more preferably 16.0%. Meanwhile, since chemical durability of the first embodiment of the lithium ion conductive material of the present invention can be improved to increase morphological stability, the upper limit of the content of the Li₂O component is 17.5%, preferably 17.2%, more preferably 17.0% and further preferably 16.7%.

The first embodiment of the lithium ion conductive material of the present invention may include one or more selected from the group consisting of a ZrO₂ component, a Y₂O₃ component, a Sc₂O₃ component, a CaO component, a MgO component and a SnO₂ component as an optional component.

The ZrO₂ component is an optional component which stabilizes the crystal structure of the crystal phase in the first embodiment of the lithium ion conductive material of the present invention to improve recyclability. Thus, the lower limit of the content of the ZrO component is preferably 0.5%, more preferably 1.0% and further preferably 2.0%. Meanwhile since the crystal phase of the rhombohedral NASICON structure can be easily formed, the upper limit of the content of the ZrO₂ component is preferably 5.0%, more preferably 4.0%, and further preferably 3.0%.

Both the Y₂O₃ component and the Sc₂O₃ component are an optional component with which lithium ion conductivity of the first embodiment of the lithium ion conductive material of the present invention can be adjusted and the mechanical strength, size, etc. of the crystal phase can be adjusted. Thus, the lower limit of the content of the Y₂O₃ component and the content of the Sc₂O₃ component are preferably 0.1%, more preferably 0.5% and further preferably 1.0%. Meanwhile, since the formation of other crystal phases can be prevented and the lithium ion conductivity of the solid electrolyte prepared by mixing and sintering with a lithium ion conductive glass material containing lithium at low temperature can be less likely to be reduced, the upper limit of the content of Y₂O₃ component and the content of the Sc₂O₃ component is preferably 2.0% and more preferably 1.5%.

The CaO component and the MgO component are an optional component which can increase lithium ion conductivity when more Li is included in the crystal phase depending on the balance of the valence. Thus, the lower limit of the content of the CaO component and the content of the MgO component are both preferably 0.5%, more preferably 1.0%, and further preferably 2.0%. Meanwhile, since reduction in the lithium ion conductivity of the solid electrolyte prepared by mixing and sintering with a lithium ion conductive glass material containing lithium at low temperature can be prevented, it is preferable that the upper limit of the content of the CaO component and the content of the MgO component are both preferably 5.0%, more preferably 4.0%, and further preferably 3.0%.

The SnO₂ component is an optional component which facilitates crystallization of the crystal phase of the first embodiment of the lithium ion conductive material of the present invention. Thus, the lower limit of the content of the SnO₂ component is preferably 0.1%, more preferably 0.5% and further preferably 1.0%. Meanwhile, since the lithium ion conductivity of the solid electrolyte prepared by mixing and sintering with a lithium ion conductive glass material containing lithium at low temperature can be less likely to be reduced, the upper limit of the content of the SnO₂ component is preferably 2.0%, and more preferably 1.5%.

The first embodiment of the lithium ion conductive material of the present invention may also contain an inorganic component including boron (B) or fluorine (F). However, in the lithium ion conductive material according to first embodiment of the present invention, it is preferable to reduce the amount of the sulfur (S) component as much as possible (for example, less than 1%, preferably less than 0.1%), and it is more preferable that the sulfur (S) component is not included. This is because reduction of the amount of the S component reduces the possibility of emission of toxic gas such as hydrogen sulfate in all-solid-state secondary batteries using a solid electrolyte prepared by mixing and sintering with a lithium ion conductive glass material containing lithium at low temperature. Furthermore, it is preferable to reduce the amount of alkali metal other than Li (for example, Na, K) as much as possible, and it is more preferable that no alkali metal other than Li is included, so as to avoid reduction of lithium ion conductivity.

In the first embodiment of the lithium ion conductive material of the present invention, the mole percent of the Al₂O₃ component described above is 0.3 to 3.0% by mole smaller than the mole percent of the Al₂O₃ component calculated by the composition formula Li₁₊ₓAlₓTi₂₋ₓP₃O₁₂ (x=0.05 to 0.4, preferably x=0.1 to 0.3) derived from the composition of Ti and Li. The lower limit is preferably 0.4% by mole, more preferably 0.5% by mole, and further preferably 1.0% by mole. The upper limit is preferably 2.8% by mole and more preferably 2.5% by mole.

In this regard, Li₁₊ₓAlₓTi₂₋ₓP₃O₁₂ (x=0.05 to 0.4) is a basic composition of LATP which is a solid electrolyte material with a Li, Al, Ti, PO₄ structure. This is derived from the composition of Al or the composition of Ti and Li. In the first embodiment of the lithium ion conductive material of the present invention, the mole percent is calculated based on the composition formula Li₁₊ₓAlₓTi₂₋ₓP₃O₁₂ (x=0.05 to 0.4) derived from the composition of Ti and Li.

More specifically, for example, when the composition of Ti is 1.7 and the composition of Li is 1.3, the composition of Al is 0.3, deriving Li_{1.3}Al_{0.3}Ti_{1.7}P₃O₁₂. Then what is necessary is that the actual mole percent of the Al₂O₃ component is 0.3 to 3.0% by mole smaller than the mole percent of the Al₂O₃ component calculated by the resulting composition formula. It is more preferable that the composition formula Li₁₊ₓAlₓTi₂₋ₓP₃O₁₂ (x=0.05 to 0.4) derived from the composition of Ti and Li is Li₁₊ₓAlₓTi₂₋ₓP₃O₁₂ in the first embodiment of the lithium ion conductive material of the present invention.

Furthermore, the mole percent of the P₂O₅ component described above is 0.2 to 2.0% by mole smaller than the mole percent of the P₂O₅ component calculated by the composition formula Li₁₊ₓAlₓTi₂₋ₓP₃O₁₂ (x=0.05 to 0.4) derived from the composition of Ti and Li. The lower limit is preferably 0.3% by mole. The upper limit is preferably 1.5% by mole, more preferably 1.2% by mole, further preferably 1.0% by mole, and still more preferably 0.8% by mole. The resulting composition formula is the same as described above.

When the content of the Al₂O₃ component and the content of the P₂O₅ component are as described above, and when the lithium ion conductive material according to the first embodiment of the present invention is mixed with a lithium ion conductive glass material containing lithium (specifically, a Li₂O—P₂O₅—Al₂O₃ glass material) and sintered at low temperature, a solid electrolyte with high lithium ion conductivity can be obtained as the lithium ion conductive glass material reacts with the material of the first embodiment on the particle interface of the material of the first embodiment, allowing the reaction product to be present on the particle interface.

<Crystal Phase>

The crystal phase in the first embodiment of the lithium ion conductive material of the present invention will be described in detail.

The first embodiment of the lithium ion conductive material of the present invention includes a predetermined amount of the respective components described above and includes a crystal phase with a rhombohedral NASICON structure (Li substituted NASICON structure) or a Li₁₊ₓAlₓTi₂₋ₓP₃O₁₂ (x≥0, preferably 2>x≥0, more preferably 0.6≥x≥0) crystal phase, composed of at least some of the above components. In other words, the first embodiment of the lithium ion conductive material of the present invention includes at least one of those crystal phases. It is preferable that all of the crystal phases in the first embodiment of the lithium ion conductive material of the present invention are one or more of the above crystal phases, but it may include a different lithium ion conductive crystal phase (for example, LISICON type, perovskite type, and garnet type). Even in those cases, the above crystal phases account for preferably 80% by mass or more, more preferably 90% by mass or more, and further preferably 95% by mass or more in total of all the crystal phases in the first embodiment of the lithium ion conductive material of the present invention. In short, it is preferable that the above crystal phases constitute the main crystal phase.

### Second Embodiment

Next, the components and the crystal phase constituting the second embodiment of the lithium ion conductive material of the present invention will be described.

<Constituent Components>

The components constituting the second embodiment of the lithium ion conductive material of the present invention will be described in detail.

The P₂O₅ component is essential for forming a crystal phase with a rhombohedral NASICON structure, a Li₁₊ₓAlₓTi₂₋ₓP₃O₁₂ (x≥0) crystal phase or a Li_{1+x+y}AlₓTi₂₋ₓSi_{y}P_{3-y}O₁₂ (x≥0, y≥0) crystal phase in the second embodiment of the lithium ion conductive material of the present invention. Thus, the lower limit of the content of the P₂O₅ component is 34.0%, preferably 34.4% and more preferably 34.8%. Meanwhile, since the formation of other crystal phases can be prevented and the lithium ion conductivity of the solid electrolyte prepared by mixing and sintering with a lithium ion conductive glass material containing lithium at low temperature can be less likely to be reduced, the upper limit of the content of the P₂O₅ component is 36.5%, preferably 36.0%, more preferably 35.5% and further preferably 35.2%.

The TiO₂ component is also essential for forming a crystal phase with a rhombohedral NASICON structure, a Li₁₊ₓAlₓTi₂₋ₓP₃O₁₂ (x≥0) crystal phase or a Li_{1+x+y}AlₓTi₂₋ₓSi_{y}P_{3-y}O₁₂ (x≥0, y≥0) crystal phase in the second embodiment of the lithium ion conductive material of the present invention. Thus, the lower limit of the content of the TiO₂ component is 42.0%, preferably 43.0%, more preferably 44.0% and further preferably 44.3%. Meanwhile, since the lithium ion conductivity of the solid electrolyte prepared by mixing and sintering with a lithium ion conductive glass material containing lithium at low temperature can be less likely to be reduced, the upper limit of the content of the TiO₂ component is 46.5%, preferably 46.0%, more preferably 45.5% and further preferably 45.2%.

The Al₂O₃ component is also essential for forming a crystal phase with a rhombohedral NASICON structure, a Li₁₊ₓAlₓTi₂₋ₓP₃O₁₂ (x≥0) crystal phase or a Li_{1+x+y}AlₓTi₂₋ₓSi_{y}P_{3-y}O₁₂ (x≥0, y≥0) crystal phase in the second embodiment of the lithium ion conductive material of the present invention. Thus, the lower limit of the content of the Al₂O₃ component is 0.6%, preferably 0.8%, more preferably 1.0% and further preferably 1.2%. Meanwhile, since the formation of other crystal phases can be prevented and the lithium ion conductivity of the solid electrolyte prepared by mixing and sintering with a lithium ion conductive glass material containing lithium at low temperature can be less likely to be reduced, the upper limit of the content of the Al₂O₃ component is 3.1%, preferably 2.5%, more preferably 2.2% and further preferably 2.0%.

The Li₂O component is essential for conferring lithium ion conductivity to the second embodiment of the lithium ion conductive material of the present invention, and for forming a crystal phase with a rhombohedral NASICON structure, a Li₁₊ₓAlₓTi₂₋ₓP₃O₁₂ (x≥0) crystal phase or a Li_{1+x+y}AlₓTi₂₋ₓSi_{y}P_{3-y}O₁₂ (x≥0, y≥0) crystal phase. Thus, the lower limit of the content of the Li₂O component is 15.0%, preferably 15.5% and more preferably 16.0%. Meanwhile, since chemical durability of the second embodiment of the lithium ion conductive material of the present invention can be improved to increase morphological stability, the upper limit of the content of the Li₂O component is 17.6%, preferably 17.0%, and more preferably 16.5%.

The SiO₂ component is essential for forming a crystal phase with a rhombohedral NASICON structure or a Li_{1+x+y}AlₓTi₂₋ₓSi_{y}P_{3-y}O₁₂ (x≥0, y≥0) crystal phase in the second embodiment of the lithium ion conductive material of the present invention. Thus, the lower limit of the content of the SiO₂ component is 0.5%, preferably 1.0% and more preferably 1.5%. Meanwhile, since the desired crystal phase can be easily formed and crystals are likely to be adjacent to each other and thus reduction in lithium ion conductivity can be prevented, the upper limit of the content of the SiO₂ component is 5.0%, more preferably 4.0%, further preferably 3.0%, and still more preferably 2.6%.

Furthermore, the second embodiment of the lithium ion conductive material of the present invention may also include one or more selected from the group consisting of a ZrO₂ component, a Y₂O₃ component, a Sc₂O₃ component, a CaO component, a MgO component and a SnO₂ component as an optional component as in the first embodiment described above. Their content is the same as those in the first embodiment described above.

The second embodiment of the lithium ion conductive material of the present invention may also contain an inorganic component including boron (B) or fluorine (F). However, it is preferable to reduce the amount of the sulfur (S) component as much as possible (for example, less than 1%, preferably less than 0.1%), and it is more preferable that the sulfur (S) component is not included. Furthermore, it is also preferable to reduce the amount of alkali metal other than Li (for example, Na, K) as much as possible, and it is more preferable that no alkali metal other than Li is included.

In the second embodiment of the lithium ion conductive material of the present invention, the mole percent of the Al₂O₃ component described above is 0.3 to 3.0% by mole smaller than the mole percent of the Al₂O₃ component calculated by the composition formula Li_{1+x+y}AlₓTi₂₋ₓSi_{y}P_{3-y}O₁₂ (x=0.05 to 0.4, y=0.05 to 0.2, preferably x=0.1 to 0.3, y=0.05 to 0.15) derived from the composition of Ti, Li and Si. The lower limit is preferably 0.4% by mole, and more preferably 0.5% by mole. The upper limit is preferably 2.8% by mole, more preferably 2.5% by mole, further preferably 2.0% by mole and still more preferably 1.5% by mole.

In this regard, Li_{1+x+y}AlₓTi₂₋ₓSi_{y}P_{3-y}O₁₂ (x=0.05 to 0.4, y=0.05 to 0.2) is also a basic composition of LATP which is a solid electrolyte material with a Li, Al, Ti, PO₄ structure. This is derived from the composition of Al and Si, or the composition of Ti, Li and Si. In the second embodiment of the lithium ion conductive material of the present invention, the mole percent is calculated based on the composition formula Li_{1+x+y}AlₓTi₂₋ₓSi_{y}P_{3-y}O₁₂ (x=0.05 to 0.4, y=0.05 to 0.2) derived from the composition of Ti, Li and Si.

More specifically, for example, when the composition of Ti is 1.8, the composition of Si is 0.1, and the composition of Li is 1.3, the composition of Al is 0.2, deriving Li_{1.3}Al_{0.2}Ti_{1.8}Si_{0.1}P_{2.9}O₁₂. Then what is necessary is that the actual mole percent of the Al₂O₃ component is 0.3 to 3.0% by mole smaller than the mole percent of the Al₂O₃ component calculated by the resulting composition formula. It is more preferable that the composition formula Li_{1+x+y}AlₓTi₂₋ₓSi_{y}P_{3-y}O₁₂ (x=0.05 to 0.4, y=0.05 to 0.2) derived from the composition of Ti, Li and Si is Li_{1.3}Al_{0.2}Ti_{1.8}Si_{0.1}P_{2.9}O₁₂ in the second embodiment of the lithium ion conductive material of the present invention.

Furthermore, the mole percent of the P₂O₅ component described above is 0.2 to 2.0% by mole smaller than the mole percent of the P₂O₅ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si. The lower limit is preferably 0.3% by mole, more preferably 0.5% by mole, and further preferably 0.8% by mole. The upper limit is preferably 1.5% by mole and more preferably 1.2% by mole. The resulting composition formula is the same as described above.

When the content of the Al₂O₃ component and the content of the P₂O₅ component are as described above, and when the lithium ion conductive material according to the second embodiment of the present invention is mixed with a lithium ion conductive glass material containing lithium (specifically, a Li₂O—P₂O₅—Al₂O₃ glass material) and sintered at low temperature, a solid electrolyte with high lithium ion conductivity can be obtained as the lithium ion conductive glass material reacts with the material of the second embodiment on the particle interface of the material of the second embodiment, allowing the reaction product to be present on the particle interface.

<Crystal Phase>

The crystal phase in the second embodiment of the lithium ion conductive material of the present invention will be described in detail.

The second embodiment of the lithium ion conductive material of the present invention includes a predetermined amount of the respective components described above and includes a crystal phase with a rhombohedral NASICON structure (Li substituted NASICON structure), Li₁₊ₓAlₓTi₂₋ₓP₃O₁₂ (x≥0, preferably 2>x≥0, more preferably 0.6≥x≥0) crystal phase, or a Li_{1+x+y}AlₓTi₂₋ₓSi_{y}P_{3-y}O₁₂ (x≥0, y≥0, preferably 2>x≥0, 3>y≥0, more preferably 0.6≥x≥0, 1≥y≥0) crystal phase, composed of at least some of the above components. In other words, the second embodiment of the lithium ion conductive material of the present invention includes at least one of those crystal phases. It is preferable that all of the crystal phases in the second embodiment of the lithium ion conductive material of the present invention are one or more of the above crystal phases, but it may include a different lithium ion conductive crystal phase (for example, LISICON type, perovskite type, and garnet type). Even in those cases, the above crystal phases account for preferably 80% by mass or more, more preferably 90% by mass or more, and further preferably 95% by mass or more in total of all the crystal phases in the second embodiment of the lithium ion conductive material of the present invention. In short, it is preferable that the above crystal phases constitute the main crystal phase.

[Form, Properties, Etc.]

Next, forms, properties and the like of the lithium ion conductive material of the present invention (the first embodiment, the second embodiment) will be described in detail.

Since the form of the lithium ion conductive material of the present invention is a material (a material for low temperature sintering) which is mixed with lithium ion conductive glass material containing lithium and sintered at low temperature to form solid electrolyte (oxide solid electrolyte), it is preferable that the lithium ion conductive material of the present invention is in the form of powder from the viewpoint of easiness in low temperature mixing and sintering. Particles in the powder are not particularly limited because it suffices that they are finely pulverized when used, and it is preferable that particles have a maximum particle size of 200 μm or less and an average particle size of 100 μm or less because coagulation should be avoided and the particles should have a particle size of about 1/10 of the diameter of zirconia beads for forming fine particles.

In this regard, the “maximum particle size” and the “average particle size” refer to the maximum particle size and the average particle size in terms of volume measured by a laser diffraction/scattering particle size distribution measuring device.

Furthermore, the lithium ion conductive material of the present invention has a lithium ion conductivity (a lithium ion conductivity before low temperature mixing and sintering of the material) at 25° C. of preferably 1.0×10⁻⁴ S/cm or more, more preferably 2.0×10⁻⁴ S/cm or more, further preferably 3.0×10⁻⁴ S/cm or more, and still more preferably 4.0×10⁻⁴ S/cm or more, which is not limited thereto. The lithium ion conductive material of the present invention has a density of preferably 2.3 g/cm³ or more, preferably 2.5 g/cm³ or more, and more preferably 2.6 g/cm³ or more, which is not limited thereto.

Furthermore, it is preferable that the lithium ion conductive material of the present invention is lithium ion conductive glass ceramics including a vitreous phase (an amorphous phase), although the material is not limited thereto. This is because a solid electrolyte with high lithium ion conductivity is likely to be formed by mixing and sintering with a lithium ion conductive glass material containing lithium at low temperature.

In this regard, the “glass ceramics” in the present invention means a material prepared by depositing crystal phase by heat treating raw material glass or a material prepared by synthesizing crystal phase by heat treating raw material glass and other materials. The glass ceramics includes both a crystal phase formed by heat treatment and an amorphous phase (non-crystal phase). In short, the “glass ceramics” is a mixture of ceramics and glass.

The lithium ion conductive material of the present invention with the structure described above is, for example, pulverized, and mixed and sintered with a lithium ion conductive glass material containing lithium at 800° C. or less (for example, 600 to 800° C., preferably 620 to 800° C., more preferably 650 to 780° C.) to improve lithium ion conductivity, and thus a solid electrolyte with high lithium ion conductivity can be obtained (for example, a lithium ion conductivity at 25° C. of 2.0×10⁻⁴ S/cm or more, preferably 3.0×10⁻⁴ S/cm or more, further preferably 3.5×10⁻⁴ S/cm or more, still more preferably 4.5×10⁻⁴ S/cm or more, still further preferably 5.0×10⁻⁴ S/cm or more, and yet more preferably 1.0×10⁻³ S/cm or more). Furthermore, the resulting solid electrolyte has a certain level or more of density (for example, a density of 2.3 g/cm³ or more, preferably 2.5 g/cm³ or more and more preferably 2.6 g/cm³ or more). While mixing and sintering in that way may reduce lithium ion conductivity of conventional lithium ion conductive materials, the lithium ion conductive material of the present invention has the above characteristics and thus can be suitably used as a raw material for producing solid electrolyte (oxide solid electrolyte) by low temperature sintering (a constituent raw material of solid electrolyte material for low temperature sintering).

[Method for Producing Lithium Ion Conductive Material of Present Invention]

Next, the method for producing the lithium ion conductive material of the present invention will be described in detail.

The lithium ion conductive material of the present invention may be produced by a usual method for producing an inorganic material, such as calcination, melting, and mixing and sintering of inorganic materials. While the method is not limited, it is preferable to produce lithium ion conductive glass ceramics by a method including: a step of preparing a raw material glass (a lithium ion conductive glass material containing lithium) by vitrifying raw materials for vitrification; a step of preparing a mixture of other raw materials; and a step of preparing a sintered body, which is lithium ion conductive glass ceramics, by mixing (for example, mixing and pulverizing) the raw material glass and the mixture of other raw materials and then sintering. Alternatively, it is also preferable to produce lithium ion conductive glass ceramics by a method including: a step of preparing a raw material glass (a lithium ion conductive glass material containing lithium) by vitrifying raw materials for vitrification; a step of preparing a preliminarily calcined body by mixing the raw material glass and other raw materials and then calcining; and a step of preparing a sintered body, which is lithium ion conductive glass ceramics, by mixing (for example, mixing and pulverizing) the preliminarily calcined body and other raw materials and then sintering.

The sintering temperature in the step of preparing a sintered body described above is not limited, and is preferably 1,000° C. or more, and more preferably 1,000° C. or more and 1,200° C. or less.

Furthermore, while the raw material glass is not limited, either, it is preferable that the raw material glass is Li₂O—P₂O₅—Al₂O₃ glass (glass including Li₂O—P₂O₅—Al₂O₃ as a basic composition) or Li₂O—P₂O₅ glass (glass including Li₂O—P₂O₅ as a basic composition) in the first embodiment, and the raw material glass is Li₂O—P₂O₅—SiO₂—Al₂O₃ glass (glass including Li₂O—P₂O₅—SiO₂—Al₂O₃ as a basic composition) or Li₂O—P₂O₅—SiO₂ glass (glass including Li₂O—P₂O₅—SiO₂ as a basic composition) in the second embodiment. These types of raw material glass may further include Y₂O₃ and the like. Furthermore, it is preferable that the mixture is a titanium phosphate-titanium oxide (TiP₂O₇—TiO₂) mixture prepared by mixing and calcining orthophosphoric acid (H₃PO₄) and titanium oxide (TiO₂), both in the first embodiment and the second embodiment.

[Method for Producing Solid Electrolyte Using Lithium Ion Conductive Material of Present Invention]

Next, the method for producing solid electrolyte using the lithium ion conductive material of the present invention will be described in detail.

A solid electrolyte using the lithium ion conductive material of the present invention may be produced by a method including a step of preparing a solid electrolyte material by mixing the lithium ion conductive material of the present invention prepared by the method described above or the like and a lithium ion conductive glass material containing lithium (glass electrolyte) which is a sintering auxiliary and a step of forming solid electrolyte (oxide solid electrolyte) by sintering the resulting solid electrolyte material at a sintering temperature of 800° C. or less.

In the preparation of the solid electrolyte material, it is preferable to mix and pulverize the lithium ion conductive material of the present invention (the above first embodiment or the second embodiment) with a lithium ion conductive glass material containing lithium, which is a sintering auxiliary. In other words, it is preferable to pulverize the two each independently and then mix them, or mix the two and then pulverize the mixture. Alternatively, they may be pulverized either before or after mixing. It is preferable to use Li₂O—P₂O₅—Al₂O₃ glass (a glass electrolyte including Li₂O—P₂O₅—Al₂O₃ as a basic composition) as the lithium ion conductive glass material containing lithium.

Furthermore, the sintering temperature in the step of forming solid electrolyte is not limited as long as it is 800° C. or less, and is more preferably 780° C. or less, further preferably 760° C. or less, and still more preferably 740° C. or less.

Moreover, in the sintering, a layer which serves as the electrode layer of the all-solid-state secondary battery (for example, a sheet-shaped positive electrode layer and negative electrode layer) may be integrally molded. A known material may be used as the electrode layer. For example, an electrode layer for all-solid-state secondary batteries prepared by mixing an electrode active material (positive electrode active material or negative electrode active material) with a conductive auxiliary, an inorganic binder and the like, if necessary, and then sintering may be used. Then by integrally molding materials including the above solid electrolyte material by low temperature sintering, an all-solid-state secondary battery may be formed. Examples of positive electrode active materials include NASICON type LiV₂(PO₄)₃, olivine type LiₓJ_{y}MtPO₄ (in which J is at least one or more selected from Al, Mg and W, MT is one or more selected from Ni, Co, Fe and Mn, x satisfies 0.9≤x≤1.5 and y satisfies 0≤y≤0.2), layered oxide and spinel oxide. Examples of negative electrode active materials include oxide including a NASICON, an olivine, or a spinel crystal, rutile oxide, anatase oxide, amorphous metal oxide and metal alloy. Examples of conductive auxiliaries include a carbon compound such as graphite, activated carbon and carbon nanotube, metal composed of at least one selected from Ni, Fe, Mn, Co, Mo, Cr, Ag and Cu, an alloy thereof, metal such as titanium, stainless steel and aluminum, and precious metal such as platinum, gold, ruthenium and rhodium.

The embodiments described above are only an example for facilitating understanding of the present invention and do not limit the present invention. More specifically, the components, crystal phases and the like illustrated above may be modified or improved without departing from the gist of the present invention, and the present invention of course includes the equivalent.

Hereinafter Examples of the present invention will be described, but the present invention is not limited to the following Examples, and may be modified in various ways within the technical scope of the present invention.

### Examples

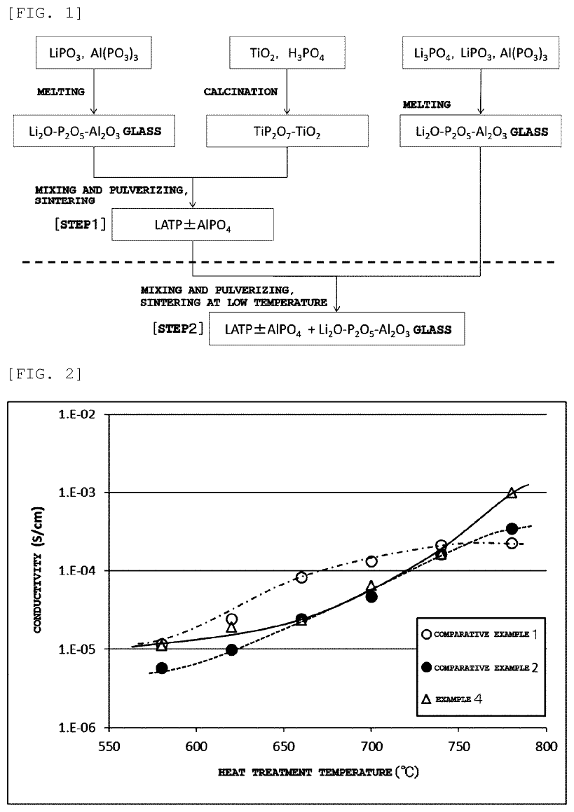

A raw material glass was prepared by vitrifying raw materials for vitrification, and then other raw materials were mixed thereto, and the resultant was pulverized and dried; and the same was sintered, or sintered after molding to give lithium ion conductive glass ceramics of Comparative Examples 1 to 3 and Examples 1 to 4 based on the flow chart shown in FIG. 1 (an example of the method for producing lithium ion conductive glass ceramics) (Step 1). For comparison of the performance of the glass ceramics, the formation of the interface in sintering of an all-solid-state secondary battery was simulated: the lithium ion conductive glass ceramics and the lithium ion conductive glass material (sintering auxiliary) were mixed and pulverized, and sintered at low temperature to prepare a solid electrolyte of Comparative Examples 1 to 3 and Examples 1 to 4 (Step 2). More specifically, the solid electrolytes were prepared by the following procedure.

First, Step 1 will be described below following the procedure. In Step 1, lithium metaphosphate, aluminum phosphate and silicon dioxide (if included in the composition) were melted and vitrified, and a mixture (calcined body) prepared by calcining titanium oxide and orthophosphoric acid were mixed thereto and pulverized, and then sintered to give lithium ion conductive glass ceramics.

<Preparation of Raw Material Glass>

Lithium metaphosphate (LiPO₃) and aluminum phosphate (Al(PO₃)₃), or the two and silicon dioxide (SiO₂) were compounded so that the mole percent on an oxide basis was the stoichiometric ratio shown in the following Table 1. The mixture was placed in a platinum pot, and melted and vitrified with thoroughly stirring at 1,100° C. or more, and cast on a metal cast plate to give various types of raw material glass, which was an amorphous material. The yield of the raw material glass including that attached to the platinum pot was 99% by weight or more in all cases.

<Preparation of Titanium Phosphate-Titanium Oxide Mixture>

Titanium oxide (TiO₂) and orthophosphoric acid (H₃PO₄, 89% by weight) were compounded so that the mole percent on an oxide basis was the stoichiometric ratio shown in the following Table 1. The mixture was mixed by a planetary centrifugal mixer (Awatori rentaro made by THINKY) and then placed in a Pyrex (registered trademark) beaker made by Pyrex, and calcined at 550° C. for 5 hours to give various types of titanium phosphate-titanium oxide mixtures (TiP₂O₇—TiO₂).

TABLE 1

| | | | | | | Difference between | |
|---|---|---|---|---|---|---|---|
| | | | | | | basic composition | |
| | Composition (mol %) | | | | | (mol %) | |
| | P₂O₅ | TiO₂ | Al₂O₃ | Li₂O | SiO₂ | P₂O₅ | Al₂O₃ |
| Comparative | 37.50 | 42.50 | 3.75 | 16.25 | 0.00 | 0.00 | 0.00 |
| Example 1 | | | | | | | |
| Comparative | 36.50 | 41.46 | 6.10 | 15.85 | 0.00 | 1.00 | 2.35 |
| Example 2 | | | | | | | |
| Comparative | 36.14 | 43.37 | 2.41 | 15.66 | 2.41 | 0.00 | 0.00 |
| Example 3 | | | | | | | |
| Example 1 | 37.18 | 43.59 | 2.56 | 16.67 | 0.00 | −0.32 | −1.19 |
| Example 2 | 36.84 | 44.74 | 1.32 | 17.11 | 0.00 | −0.66 | −2.43 |
| Example 3 | 35.19 | 44.44 | 1.85 | 16.05 | 2.47 | −0.96 | −0.56 |
| Example 4 | 35.00 | 45.00 | 1.25 | 16.25 | 1.80 | −1.14 | −1.16 |

<Synthesis of Lithium Ion Conductive Glass Ceramics>

Each of the various types of raw material glass described above and the various types of titanium phosphate-titanium oxide mixtures were pulverized to 106 μm or less, and then compounded so that the mole percent on an oxide basis was the stoichiometric ratio shown in the above Table 1. 1-propanol was added thereto and the mixture was pulverized and mixed using ϕ 2 mm zirconia beads (YTZ beads made by Nikkato Corporation) and a 500 cc zirconia pot by using a planetary ball mill under conditions of 250 rpm and 2 hours (pulverized for 5 minutes, suspended for 1 minute). The slurry was separated from the zirconia beads after pulverization with a sieve, and then the resulting slurry was dried by using a shelf dryer with solvent recovery system (made by The Institute of Creative Chemistry Co., Ltd.).

The dried mixed powder described above was disintegrated using an alumina pestle and mortar to pass a 500-μm mesh, and then 1.5 g of the resultant was collected and molded using a ϕ 20 mm mold by applying a pressure of 20 kN to give pellets for measuring lithium ion conductivity.

Furthermore, the dried mixed powder which had not been disintegrated was placed in a platinum pot, and separately, the above pellets for measuring lithium ion conductivity were put on a platinum plate and sintered in ambient air at 1,100° C. for 1 hour to give the sintered bodies and the sintered pellets, i.e., lithium ion conductive glass ceramics, of Comparative Examples 1 to 3 and Examples 1 to 4. The above procedure is Step 1 (FIG. 1). FIG. 1 illustrates an example in which no silicon dioxide was used.

Here, Table 1 above shows the difference between the composition of the P₂O₅ component and the Al₂O₃ component in mole percent on an oxide basis in the sintered bodies and the sintered pellets prepared in Step 1 and the composition of the P₂O₅ component and the Al₂O₃ component (% by mole) calculated by Li_{1.3}Al_{0.3}Ti_{1.7}P₃O₁₂ (the same as the composition of Comparative Example 1), which is a composition formula of Li₁₊ₓAlₓTi₂₋ₓP₃O₁₂ (x=0.05 to 0.4) derived from the composition of Ti and Li, or Li_{1.3}Al_{0.2}Ti_{1.8}Si_{0.1}P_{2.9}O₁₂ (the same as the composition of Comparative Example 3), which is a composition formula of Li_{1+x+y}AlₓTi₂₋ₓSi_{y}P_{3-y}O₁₂ (x=0.05 to 0.4, y=0.05 to 0.2) derived from the composition of Ti, Li and Si. In short, in Comparative Example 2, Example 1 and Example 2, the difference in the composition between Comparative Example 1 is shown, and in Example 3 and Example 4, the difference in the composition between Comparative Example 3 is shown. As shown in Table 1, the lithium ion conductive glass ceramics of Comparative Example 2 prepared in Step 1 includes a larger amount of the P₂O₅ component and the Al₂O₃ component (in other words, AlPO₄ component, FIG. 1) than those in the composition formula derived as described above. Meanwhile, the amount of the P₂O₅ component and the Al₂O₃ component (in other words, AlPO₄ component, FIG. 1) in the lithium ion conductive glass ceramics of Examples 1 to 4 prepared in Step 1 is a certain amount smaller than that in the composition formula derived as described above.

Then, for the resulting sintered pellets, a gold electrode was formed on both sides of the sintered pellets as a blocking electrode using a magnetron sputtering device (SC-701HMC made by Sanyu Electron Co., Ltd.); and the impedance was measured using Electrochemical Measurement System (SP300 made by Biologic) at 25° C. under conditions of a frequency of 0.1 Hz to 7 MHz, an amplitude voltage of 10 mV and an open circuit voltage to calculate the lithium ion conductivity. Furthermore, the surface of the sintered pellets was polished and dried using #800 and #2000 water proof abrasive paper and 1-propanol, and then the diameter, thickness and weight were measured using a vernier caliper, a micrometer and an electronic balance, respectively, to calculate the density. The lithium ion conductivity and the density of the sintered pellets prepared in Step 1 are shown in the following Table 2.

<Mixing and Low Temperature Sintering of Lithium Ion Conductive Glass Ceramics and Lithium Ion Conductive Glass Material: Step 2>

Next, Step 2 will be described below following the procedure. First, the respective sintered bodies, which were not pellets, prepared in the above Step 1 and 56% by mole Li₂O—38% by mole P₂O₅—6% by mole Al₂O₃ glass (lithium ion conductive glass material (glass electrolyte)), which was a sintering auxiliary, were both pulverized to 106 μm or less. Then they were compounded so that the proportion of the sintered body was 88% by weight and the proportion of the lithium ion conductive glass material was 12% by weight, and 1-propanol was added thereto. The mixture was pulverized and mixed using ϕ 2 mm zirconia beads (YTZ beads made by Nikkato Corporation) and a 500 cc zirconia pot by using a planetary ball mill under conditions of 250 rpm and 2 hours (pulverized for 5 minutes, suspended for 1 minute). The slurry was separated from the zirconia beads after pulverization with a sieve, and then the resulting slurry was dried by using a shelf dryer with solvent recovery system (made by The Institute of Creative Chemistry Co., Ltd.).

The dried mixed powder described above was disintegrated using an alumina pestle and mortar to pass a 500-μm mesh, and then 1.5 g of the resultant was collected and molded using a ϕ 20 mm mold by applying a pressure of 20 kN to give various types of pellets for measuring lithium ion conductivity.

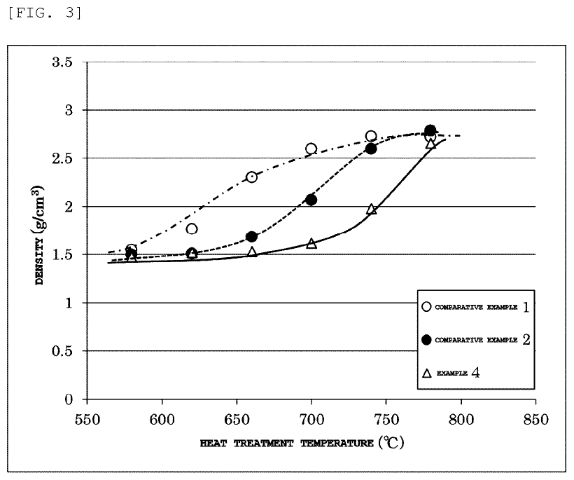

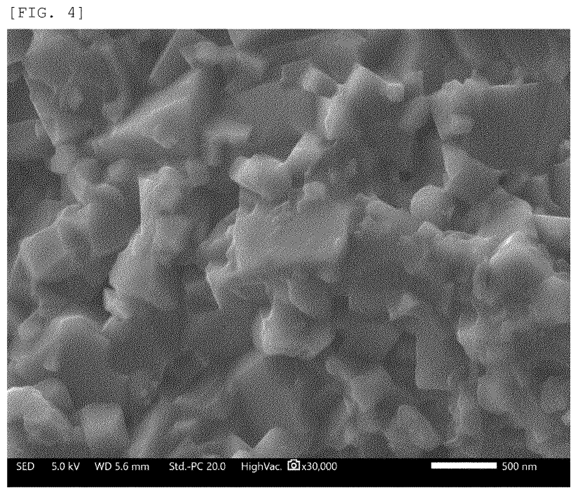

The pellets for measuring lithium ion conductivity were heat treated in ambient air at 580° C., 620° C., 660° C., 700° C., 740° C. or 780° C. for 1 hour to give sintered pellets, which were a solid electrolyte. Then the lithium ion conductivity and the density were calculated by the same method of calculation for the sintered pellets in Step 1 described above. The lithium ion conductivity and the density of the sintered pellets prepared by sintering at 780° C. in Step 2 are shown in the following Table 2. For Comparative Example 1, Comparative Example 2 and Example 4, the lithium ion conductivity (conductivity) and the density of the sintered pellets prepared at the respective sintering temperatures are shown in FIG. 2 and FIG. 3.

TABLE 2

| | Step 1 | | Step 2 | |
|---|---|---|---|---|
| | Conductivity | Density of | Conductivity | Density of |
| | of sintered | sintered | of sintered | sintered |
| | pellet | pellet | pellet | pellet |
| | (S/cm) | (g/cm³) | (S/cm) | (g/cm³) |
| Comparative | 6.2 × 10⁻⁴ | 2.76 | 1.7 × 10⁻⁴ | 2.75 |
| Example 1 | | | | |
| Comparative | 1.2 × 10⁻³ | 2.10 | 3.5 × 10⁻⁴ | 2.80 |
| Example 2 | | | | |
| Comparative | 5.4 × 10⁻⁴ | 2.00 | 2.3 × 10⁻⁴ | 2.73 |
| Example 3 | | | | |
| Example 1 | 2.4 × 10⁻⁴ | 2.82 | 4.9 × 10⁻⁴ | 2.73 |
| Example 2 | 1.9 × 10⁻⁴ | 2.79 | 3.9 × 10⁻⁴ | 2.69 |
| Example 3 | 6.5 × 10⁻⁴ | 2.68 | 1.5 × 10⁻³ | 2.63 |
| Example 4 | 4.9 × 10⁻⁴ | 2.75 | 1.0 × 10⁻³ | 2.66 |

<Results of Evaluation>

The results show that all of the sintered pellets of Comparative Examples 1 to 3 prepared in Step 1 have a high lithium ion conductivity of 5×10⁻⁴ S/cm or more. In particular, although the sintered pellets of Comparative Example 2 required a high sintering temperature of 1,100° C., the pellets had a lithium ion conductivity of 1.2×10⁻³ S/cm, which was similar to document data. However, the lithium ion conductivity of all of the sintered pellets of Comparative Examples 1 to 3 prepared in Step 2 was reduced to ½ to ⅓ of that of the sintered pellets prepared in Step 1. Meanwhile, in Examples 1 to 4, all of the sintered pellets prepared in Step 2 had higher lithium ion conductivity than sintered pellets prepared in Step 1. Furthermore, the sintered pellets of Examples 1 to 4 prepared in Step 2 had higher lithium ion conductivity than the sintered pellets of Comparative Examples 1 to 3 prepared in Step 2. In particular, the results show that the sintered pellets of Example 3 prepared in Step 2 in which the formation of the interface in sintering of an all-solid-state secondary battery was simulated had a lithium ion conductivity of 1.5×10⁻³ S/cm, which was significantly high for a LATP oxide solid electrolyte.

As shown in Table 1 above, in the composition of the sintered pellets (lithium ion conductive glass ceramics) of Examples 1 to 4 prepared in Step 1, the amount of the Al₂O₃ component and the P₂O₅ component (substantially the AlPO₄ component) is a certain amount smaller than that in Li_{1.3}Al_{0.3}Ti_{1.7}P₃O₁₂ (the composition of Comparative Example 1), which is a basic composition of LATP derived from the composition of Ti and Li, or Li_{1.3}Al_{0.2}Ti_{1.8}Si_{0.1}P_{2.9}O₁₂ (the composition of Comparative Example 3), which is a basic composition of LATP derived from the composition of Ti, Li and Si. This suggests that when the Li₂O—P₂O₅—Al₂O₃ lithium ion conductive glass material (glass electrolyte) was mixed and the mixture was sintered at low temperature in Step 2, the glass electrolyte reacted with the lithium ion conductive glass ceramics on the interface of the particles; and the presence of the reaction product on the interface of the particles prevented an excess amount of the glass electrolyte (about 1×10⁻⁷ S/cm) whose lithium ion conductivity was very small as a single body from being present on the interface of the particles. Meanwhile, in Comparative Examples 1 to 3, the sintered pellets (lithium ion conductive glass ceramics) prepared in Step 1 were optimal, and thus suggesting that the lithium ion conductivity of the sintered pellets (solid electrolyte) prepared in Step 2 was reduced by the amount of the glass electrolyte existing on the interface of the particles. Furthermore, if the amount of the glass electrolyte to be mixed in Step 2 is excessively reduced, the glass electrolyte does not work properly and thus suggesting that the density and the lithium ion conductivity of the resulting sintered pellets (solid electrolyte) are reduced.

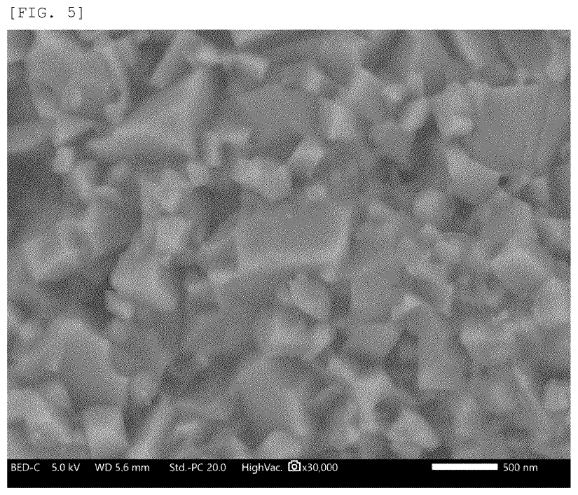

FIG. 4 is a secondary electron image of a broken-out section of the sintered pellets prepared by sintering at 780° C. in Step 2 of Example 4, and FIG. 5 is a backscattered electron image thereof. For the observation and detection, an electronic microscope JSM-700HR made by JEOL Ltd. was used. Generally, when an object is observed at a low accelerated voltage of about 5 kV, the secondary electron image is for the observation of the surface of particles while the backscattered electron image is for the observation of the inside of the particle. The presence of a matter in the secondary electron image, which is not visually observed in the backscattered electron image, suggests that there is something attached on the surface of particles of the sintered pellets. Since this is an image of a broken-out section, we assume that there is an attachment (a reaction product of glass electrolyte and lithium ion conductive glass ceramics) on the interface of particles, and the glass electrolyte contributes to the formation of the interface of the particles.

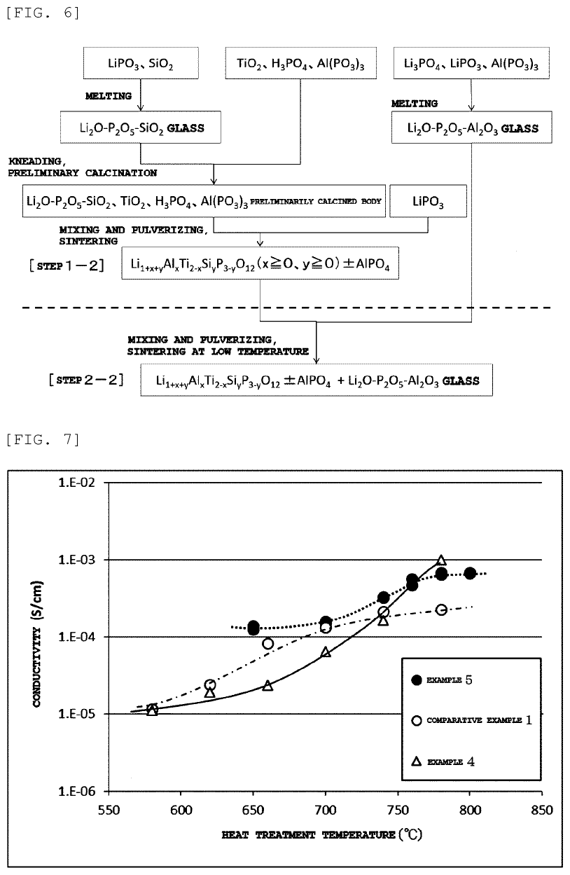

Furthermore, according to the flow chart shown in FIG. 6 (a modified example of the method for producing lithium ion conductive glass ceramics), a raw material glass was prepared by vitrifying raw materials for vitrification, and then other raw materials were kneaded and preliminarily calcined and the resultant was further mixed thereto and pulverized, and then sintered, or sintered after molding to give lithium ion conductive glass ceramics of Comparative Example 4 and Examples 5 and 6 (Step 1-2). For comparison of the performance of the glass ceramics, the formation of interface in sintering an all-solid-state secondary battery was simulated: the lithium ion conductive glass ceramics and the lithium ion conductive glass material (sintering auxiliary) were mixed and pulverized, and sintered at low temperature to prepare a solid electrolyte of Comparative Example 4 and Examples 5 and 6. More specifically, the solid electrolytes were prepared by the following procedure.

First, Step 1-2 will be described below following the procedure. In Step 1-2, lithium metaphosphate and silicon dioxide (if included in the composition) were melted and vitrified, and titanium oxide, orthophosphoric acid and aluminum phosphate were kneaded and then preliminarily calcined to prepare a preliminarily calcined body. Furthermore, lithium metaphosphate was mixed to the preliminarily calcined body and the resultant was pulverized, and then sintered to give lithium ion conductive glass ceramics.

<Preparation of Raw Material Glass>

Lithium metaphosphate (LiPO₃), or lithium metaphosphate and silicon dioxide (SiO₂) were compounded so that the mole percent on an oxide basis was the stoichiometric ratio shown in the following Table 3. Note that since lithium metaphosphate was also mixed after preliminary calcination, the amount was half the stoichiometric ratio at that stage. The mixture was placed in a platinum pot, and melted and vitrified with thoroughly stirring at 1,100° C. or more, and cast on a metal cast plate to give various types of raw material glass, which was an amorphous material. The yield of the raw material glass including that attached to the platinum pot was 99% by weight or more in all cases.

<Preparation of Preliminarily Calcined Body of Raw Material Glass, Titanium Oxide, Orthophosphoric Acid and Aluminum Phosphate>

Titanium oxide (TiO₂), orthophosphoric acid (H₃PO₄, 89% by weight), aluminum phosphate (Al(PO₃)₃), and the above raw material glass were compounded so that the mole percent on an oxide basis was the stoichiometric ratio shown in the following Table 3. The mixture was kneaded by a planetary centrifugal mixer (Awatori rentaro made by THINKY) and then placed in a Pyrex (registered trademark) beaker made by Pyrex, and calcined at 550° C. for 5 hours to give a preliminarily calcined body of a mixture of various types of raw material glass, titanium oxide, orthophosphoric acid and aluminum phosphate.

TABLE 3

| | | | | | | Difference between | |
|---|---|---|---|---|---|---|---|
| | | | | | | basic composition | |
| | Composition (mol %) | | | | | (mol %) | |
| | P₂O₅ | TiO₂ | Al₂O₃ | Li₂O | SiO₂ | P₂O₅ | Al₂O₃ |
| Comparative | 36.14 | 43.37 | 2.41 | 15.66 | 2.41 | 0.00 | 0.00 |
| Example 4 | | | | | | | |
| Example 5 | 35.00 | 45.00 | 1.25 | 16.25 | 2.50 | −1.14 | −1.16 |
| Example 6 | 37.18 | 43.59 | 2.56 | 16.67 | 0.00 | −0.32 | −1.19 |

<Synthesis of Lithium Ion Conductive Glass Ceramics>

Each of the preliminarily calcined body described above and lithium metaphosphate were pulverized to 106 μm or less, and then compounded so that the mole percent on an oxide basis was the stoichiometric ratio shown in the above Table 3. 1-propanol was added thereto and the mixture was pulverized and mixed using ϕ 2 mm zirconia beads (YTZ beads made by Nikkato Corporation) and a 500 cc zirconia pot by using a planetary ball mill under conditions of 250 rpm and 2 hours (pulverized for 5 minutes, suspended for 1 minute). The slurry was separated from the zirconia beads after pulverization with a sieve, and then the resulting slurry was dried by using a shelf dryer with solvent recovery system (made by The Institute of Creative Chemistry Co., Ltd.).

The dried mixed powder described above was disintegrated using an alumina pestle and mortar to pass a 500-μm mesh, and then 1.5 g of the mixed powder was collected and molded using a ϕ 20 mm mold by applying a pressure of 20 kN to give pellets for measuring lithium ion conductivity.

Furthermore, the dried mixed powder which had not been disintegrated was placed in a platinum pot, and separately, the above pellets for measuring lithium ion conductivity were put on a platinum plate and sintered in ambient air at 1,000° C. for 1 hour to give the sintered bodies and the sintered pellets, i.e., lithium ion conductive glass ceramics, of Comparative Example 4 and Examples 5 and 6. The above procedure is Step 1-2 (FIG. 6). FIG. 6 illustrates an example in which silicon dioxide was used.

Here, Table 3 above shows the difference between the composition of the P₂O₅ component and the Al₂O₃ component in mole percent on an oxide basis in the sintered bodies and the sintered pellets of Example 5 and Example 6 prepared in Step 1-2 and the composition of the P₂O₅ component and the Al₂O₃ component (% by mole) calculated by Li_{1.3}Al_{0.3}Ti_{1.7}P₃O₁₂ (the same as the composition of Comparative Example 1 described above), which is a composition formula of Li₁₊ₓAlₓTi₂₋ₓP₃O₁₂ (x=0.05 to 0.4) derived from the composition of Ti and Li, or Li_{1.3}Al_{0.2}Ti_{1.8}Si_{0.1}P_{2.9}O₁₂ (the same as the composition of Comparative Example 4), which is a composition formula of Li_{1+x+y}AlₓTi₂₋ₓSi_{y}P_{3-y}O₁₂ (x=0.05 to 0.4, y=0.05 to 0.2) derived from the composition of Ti, Li and Si. In short, in Example 5, the difference in the composition between Comparative Example 4 is shown, and in Example 6, the difference in the composition between Comparative Example 1 described above is shown. As shown in Table 3, the amount of the P₂O₅ component and the Al₂O₃ component (in other words, AlPO₄ component) in the lithium ion conductive glass ceramics of Examples 5 and 6 prepared in Step 1-2 is a certain amount smaller than that in the composition formula derived as described above.

Then, for the resulting sintered pellets, a gold electrode was formed on both sides of the sintered pellets as a blocking electrode using a magnetron sputtering device (SC-701HMC made by Sanyu Electron Co., Ltd.); and the impedance was measured using Electrochemical Measurement System (SP300 made by Biologic) at 25° C. under conditions of a frequency of 0.1 Hz to 7 MHz, an amplitude voltage of 10 mV and open circuit voltage to calculate the lithium ion conductivity. Furthermore, the surface of the sintered pellets was polished and dried using #800 and #2000 water proof abrasive paper and 1-propanol, and then the diameter, thickness and weight were measured using a vernier caliper, a micrometer and an electronic balance, respectively, to calculate the density. The lithium ion conductivity and the density of the sintered pellets prepared in Step 1-2 are shown in the following Table 4.

<Mixing and Low Temperature Sintering of Lithium Ion Conductive Glass Ceramics and Lithium Ion Conductive Glass Material: Step 2-2>

Next, Step 2-2 will be described below following the procedure. First, the respective sintered bodies, which were not pellets, prepared in the above Step 1-2 and 56% by mole Li₂O—38% by mole P₂O₅—6% by mole Al₂O₃ glass (lithium ion conductive glass material (glass electrolyte)), which was a sintering auxiliary, were both pulverized to 106 μm or less. Then they were compounded so that the proportion of the sintered body was 88% by weight and the proportion of the lithium ion conductive glass material was 12% by weight, and 1-propanol was added thereto. The mixture was pulverized and mixed using ϕ 2 mm zirconia beads (YTZ beads made by Nikkato Corporation) and a 500 cc zirconia pot by using a planetary ball mill under conditions of 250 rpm and 2 hours (pulverized for 5 minutes, suspended for 1 minute). The slurry was separated from the zirconia beads after pulverization with a sieve, and then the resulting slurry was dried by using a shelf dryer with solvent recovery system (made by The Institute of Creative Chemistry Co., Ltd.)

The dried mixed powder described above was disintegrated using an alumina pestle and mortar to pass a 500-μm mesh, and then 1.5 g of the resultant was collected and molded using a ϕ 20 mm mold by applying a pressure of 20 kN to give various types of pellets for measuring lithium ion conductivity.

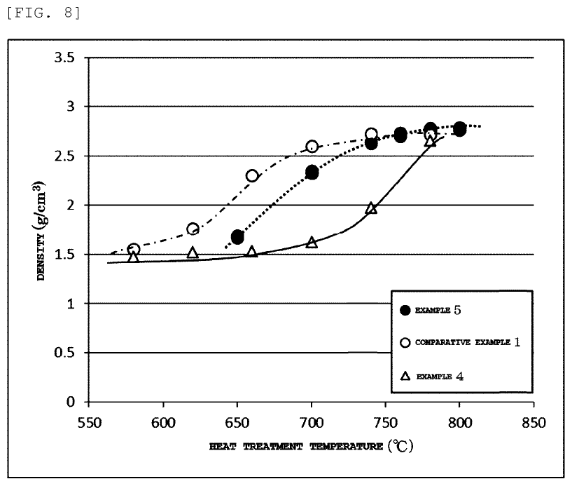

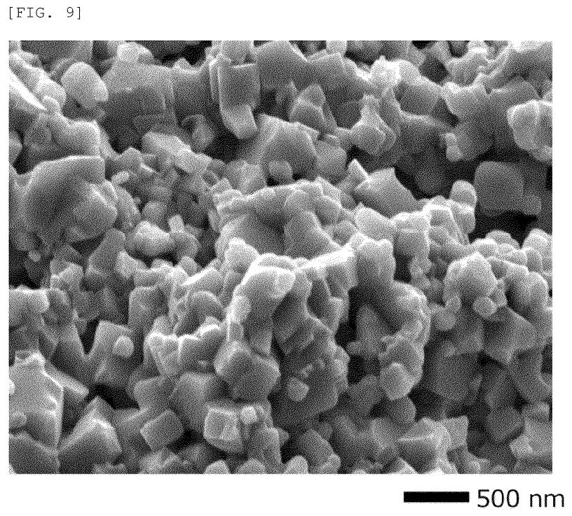

The pellets for measuring lithium ion conductivity were heat treated in ambient air at 650° C., 700° C., 740° C., 760° C., 780° C. or 800° C. for 1 hour to give sintered pellets, which were a solid electrolyte. Then the lithium ion conductivity and the density were calculated by the same method of calculation for the sintered pellets in Step 1-2 described above. The lithium ion conductivity and the density of the sintered pellets prepared by sintering at 740° C. in Step 2-2 are shown in the following Table 4. For Example 5, the relationship between the lithium ion conductivity (conductivity) and the density of the sintered pellets prepared at the respective sintering temperatures are shown in FIG. 7 and FIG. 8 in comparison with those in Comparative Example 1 and Example 4 described above.

TABLE 4

| | Step 1-2 | | Step 2-2 | |
|---|---|---|---|---|
| | Conductivity | Density of | Conductivity | Density of |
| | of sintered | sintered | of sintered | sintered |
| | pellet | pellet | pellet | pellet |
| | (S/cm) | (g/cm³) | (S/cm) | (g/cm³) |
| Comparative | 6.2 × 10⁻⁴ | 2.76 | 0.8 × 10⁻⁴ | 2.75 |
| Example 4 | | | | |
| Example 5 | 7.2 × 10⁻⁴ | 2.76 | 3.3 × 10⁻⁴ | 2.64 |
| Example 6 | 4.3 × 10⁻⁴ | 2.58 | 2.3 × 10⁻⁴ | 2.73 |

<Results of Evaluation>

The results show that both of the sintered pellets of Examples 5 and 6 prepared in Step 1-2 have a high lithium ion conductivity of 4×10⁻⁴ S/cm or more. This is the same as properties in Examples 1 to 4 described above. Meanwhile, the results show that even when the calcination temperature was as low as 740° C. in Step 2-2 in which formation of the interface in sintering of an all-solid-state secondary battery was simulated, a solid electrolyte with a lithium ion conductivity of more than 2×10⁻⁴ S/cm and a density of more than 2.6 g/cm³ can be obtained.

FIG. 9 is a secondary electron image of a broken-out section of the sintered pellets prepared by sintering at 700° C. in Step 2-2 of Example 5. For the observation and detection, an electronic microscope JSM-700HR made by JEOL Ltd. was used. The conditions were the same as those in FIG. 4. The results show that particles are thoroughly joined even in sintering at 700° C.

The present application claims priority to Japanese Patent Application No. 2021-060218 filed Mar. 31, 2021, the entire disclosure of which is hereby incorporated.

1. A lithium ion conductive material comprising, in mole percent on an oxide basis,
36.6 to 37.3% of a P₂O₅ component,
43.0 to 48.1% of a TiO₂ component,
0.6 to 3.2% of an Al₂O₃ component, and
13.9 to 17.5% of a Li₂O component,
wherein a mole percent of the Al₂O₃ component is 0.3 to 3.0% by mole smaller than a mole percent of an Al₂O₃ component calculated by the composition formula Li₁₊ₓAlₓTi₂₋ₓP₃O₁₂ (x=0.05 to 0.4) derived from the composition of Ti and Li, and
a mole percent of the P₂O₅ component is 0.2 to 2.0% by mole smaller than a mole percent of a P₂O₅ component calculated by the composition formula Li₁₊ₓAlₓTi₂₋ₓP₃O₁₂ (x=0.05 to 0.4) derived from the composition of Ti and Li, and
wherein the lithium ion conductive material further comprises a crystal phase with a rhombohedral NASICON structure or a Li₁₊ₓAlₓTi₂₋ₓP₃O₁₂ (x≥0) crystal phase.

2. A lithium ion conductive material comprising, in mole percent on an oxide basis,
34.0 to 36.5% of a P₂O₅ component,
42.0 to 46.5% of a TiO₂ component,
0.6 to 3.1% of an Al₂O₃ component,
15.0 to 17.6% of a Li₂O component, and
0.5 to 5.0% of a SiO₂ component,
wherein a mole percent of the Al₂O₃ component is 0.3 to 3.0% by mole smaller than a mole percent of an Al₂O₃ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and
a mole percent of the P₂O₅ component is 0.2 to 2.0% by mole smaller than a mole percent of a P₂O₅ component calculated by the composition formula Li_{1+x+y}AlₓTi₂₋ₓSi_{y}P_{3-y}O₁₂ (x=0.05 to 0.4, y=0.05 to 0.2) derived from the composition of Ti, Li and Si, and
wherein the lithium ion conductive material further comprises a crystal phase with a rhombohedral NASICON structure, a Li₁₊ₓAlₓTi₂₋ₓP₃O₁₂ (x≥0) crystal phase, or a Li_{1+x+y}AlₓTi₂₋ₓSi_{y}P_{3-y}O₁₂ (x≥0, y≥0) crystal phase.

3. The lithium ion conductive material according to claim 1, which is lithium ion conductive glass ceramics.

4. A solid electrolyte material formed by mixing the lithium ion conductive material according to claim 1 and a lithium ion conductive glass material containing lithium.

5. An all-solid-state secondary battery formed of a material comprising the solid electrolyte material according to claim 4.

6. The lithium ion conductive material according to claim 2, which is lithium ion conductive glass ceramics.

7. A solid electrolyte material formed by mixing the lithium ion conductive material according to claim 2 and a lithium ion conductive glass material containing lithium.

8. An all-solid-state secondary battery formed of a material comprising the solid electrolyte material according to claim 7.
